(19) United States
(12) Patent Application Publication
(10) Pub. No.: US 2008/0096120 A1
(43) Pub. Date: Apr. 24, 2008

(54) TONER

(75) Inventors: Go Yamaguchi, Tokyo (JP); Asao Matsushima, Tokyo (JP); Noboru Ueda, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 11/861,925

(22) Filed: Sep. 26, 2007

(30) Foreign Application Priority Data
Oct. 24, 2006 (JP) JP2006-288954

(51) Int. Cl. G03G 9/093

(52) U.S. Cl. 430/110.2; 430/111.4

(57) ABSTRACT

An eletrophotographic toner comprising toner particles each containing a colorant and a resin, wherein the resin in the toner particle satisfies the following Formulas (1) and (2): Formula (1) 20≦Tg≦40, Formula (2) 15≦(Ta−Tg)≦40, wherein Tg (° C.) is a glass transition point of the resin; and Ta (° C.) is a 50% aggregation temperature of the resin.

This application is based on Japanese Patent Application No. 2006-288954 filed on Oct. 24, 2006 with Japan Patent Office, the entire content of which is hereby incorporated by reference.

### TECHNICAL FIELD

The present invention relates to a toner (or called as an eletrophotographic toner) employed for forming visible images using eletrophotographic systems or printers.

### BACKGROUND

Conventionally, as a method of fixing toner images formed on a transfer medium such as paper, for example, a heat roller fixing method has been widely utilized, in which a transfer medium carrying toner images thereon is passed between a heat roller and a pressure roller to fix the images. To achieve fixability in the heat fixing roller method, that is, to achieve adhesion properties of the toner to the transfer medium, the heat roller requires a relatively large amount of heat.

Recently, however, energy conservation for electrophotographic copying machines and printers, which employ a heat roller fixing method, has been demanded to counteract warming in the global environment. To cope with such a demand, much research effort has been directed toward the development of technologies to decrease the amount of heat required to fix toner images, by decreasing the glass transition point of the employed toner.

Decreasing the glass transition point of a toner is an effective way to improve low temperature fixability. However, in a toner exhibiting low glass transition point, when printing up to tens of thousands of copies, the blocking phenomenon due to toner aggregation tends to occur, resulting in fogging and non-uniform images, due to poor electrical charging of the formed images. Ultimately, there has been the problem that it is impossible for the toner to exhibit adequate heat stability or aggregation resistance.

To solve the problems, a core-shell structure toner has been proposed, in which the surface of the core particles incorporating a resin exhibiting a low glass transition point is coated with a shell incorporating a resin exhibiting a high glass transition point (refer to Patent Documents 1).

However, in the core-shell structure toner, when employing a toner prepared via formation of a firm shell exhibiting high aggregation resistance in order to obtain stable visible images, adhesion to the transfer medium during fixing is often inadequate. As a result, it has been difficult to ensure low temperature fixability.

Alternatively, with the intent to ensure low temperature fixability, in cases when preparing core particles which exhibit low temperature melting properties, as well as forming a firm shell to improve adhesion to the transfer medium, low temperature fixability (namely anti-offsetting properties) is satisfactory and the fixed images exhibit no appearance problems; however, the following problems continue: the fixed images tend to be smudged during handling the printed sheets; and image durability of the printed sheets filed with other sheets suffers, resulting in soiled hands, as well as the images themselves and the other sheets being smudged.

(Patent Document 1) Japanese Patent Publication Open to Public Inspection No. 2001-235894

### SUMMARY

The present invention has been achieved to overcome these problems. An object of the present invention is to provide a toner which exhibits low temperature fixability and high durability of fixed images against rubbing, as well as preventing fogging and non-uniform images by inhibiting toner aggregation, even when printing up to tens of thousands of copies.

An object of the present invention can be achieved by the following embodiments

(1) An embodiment of the present invention is an electrophotographic toner comprising toner particles each containing a colorant and a resin,

wherein the resin in the toner particle satisfies the following Formulas (1) and (2):

20≦Tg≦40 Formula (1)

15≦(Ta−Tg)≦40, Formula (2)

wherein Tg (° C.) is a glass transition point of the resin; and Ta (° C.) is a 50% aggregation temperature of the resin.

(2) Another embodiment of the present invention is an electrophotographic toner, wherein the resin in the toner particle satisfies the following Formulas (3) and (4):

25≦Tg≦35 Formula (1)

20≦(Ta−Tg)≦35. Formula (2)

(3) Another embodiment of the present invention is an electrophotographic toner, wherein the toner particle has a core/shell structure comprising a core and a shell covering a surface of the core.

(4) Another embodiment of the present invention is an electrophotographic toner having a core/shell structure, wherein a first glass transition temperature (Tg1) of a first resin in the core and a second glass transition temperature (Tg2) of a second resin in the shell satisfy the following Formula (5):

Tg1<Tg2. Formula (5)

(5) Another embodiment of the present invention is an electrophotographic toner having a core/shell structure, wherein Tg2 is larger than Tg1 by 20° C. or more.

(6) Another embodiment of the present invention is an electrophotographic toner having a core/shell structure, wherein a first solubility parameter (SP1) of a first resin in the core and a second solubility parameter (SP2) of a second resin in the shell satisfy the following Formula (5B):

0.19≦|SP1−SP2|≦1.12 Formula (5B)

(7) Another embodiment of the present invention is an electrophotographic toner having a core/shell structure, wherein a first solubility parameter (SP1) of a first resin in the core and a second solubility parameter (SP2) of a second resin in the shell satisfy the following Formula (5C):

0.32≦|SP1−SP2≦1.12 Formula (5C)

(8) Another embodiment of the present invention is an electrophotographic toner having a core/shell structure, wherein an average layer thickness obtained from thicknesses at 8 points of the shell is 100 to 300 nm; and a ratio of Hmax/Hmin is less than 1.50, provided that Hmax is a maximum layer thickness of the shell and Hmin is a minimum layer thickness of the shell.

(9) Another embodiment of the present invention is an electrophotographic toner having a core/shell structure, wherein an entire portion of the surface of the core is covered with the shell.

The toner of the present invention exhibits a glass transition point Tg of 20-40° C., and also the difference (Ta−Tg) between the 50% aggregation rate temperature Ta and the glass transition point Tg is in the range of 15-40° C., whereby the toner exhibits high fluidity in the state of being melted. Therefore, adequate low temperature fixability is achieved since adequate adhesion to paper, serving as a transfer medium, during heat-melt fixing is realized, and also due to adequate aggregation resistance of the toner, image defects due to aggregation is prevented, whereby the targeted image forming properties of the toner are ensured. As a result, it is possible that stable visible toner images are formed even when printing up to tens of thousands of copies, since the toner exhibits low temperature fixability, and the fixed images exhibit high durability against rubbing.

### BRIEF DESCRIPTION OF THE DRAWINGS

FIG. 1 is a diagram showing the relationship of the temperature and the aggregation rate in aggregation rate measurement of a toner.

FIG. 2 is a schematic view showing one example of an image forming apparatus employed in the present invention.

### DESCRIPTION OF THE PREFERRED EMBODIMENTS

With respect to the toner of the present invention, the glass transition point Tg (° C.) of the toner itself satisfies Formula (1), and also both the 50% aggregation rate temperature Ta (° C.) and the glass transition point Tg of the toner satisfy Formula (2).

20≦Tg≦40 (° C.) Formula (1)

15≦(Ta−Tg)≦40 (° C.) Formula (2)

Wherein, (Ta−Tg) is an indicator for the temperature characteristics of the toner capable of comprehensively evaluating both adhesion force of the toner to a transfer medium and image stability thereof, varying with the degree of aggregation due to heat and stress to the toner. By allowing this value to be at least 15° C. and to be at most 40° C., a toner exhibiting low temperature fixability is realized, and also high image durability of fixed images against rubbing is achieved. Further, the toner exhibits adequate aggregation resistance.

When (Ta−Tg) is less than 15° C., aggregation resistance is insufficient. On the other hand, when (Ta−Tg) is more than 40° C., since the toner then exhibits poor adhesion force to the transfer medium, it is difficult to form a toner exhibiting both low temperature fixability and high durability of fixed images against rubbing.

To ensure that low temperature fixability of a toner is satisfactory, it is necessary to improve adhesion force to a transfer medium such as paper. In this case, melting characteristics and fluidity of the binding resin, constituting a toner, need to be enhanced during heat fixing. Consequently, a resin, exhibiting a low glass transition point, is still being sought.

On the other hand, to ensure aggregation resistance of a toner is satisfactory, so as to prevent the surface of the toner particles from fusing each even when the toner is subjected to heating and stress during toner storage or within a developing device, a binding resin, exhibiting a high glass transition point, is being sought since melting resistance thereof to heat is necessary.

To allow these contradictory requirements to be satisfactorily met, it is preferable to employ at least two kinds of resins to constitute a toner. One example is the structure of a core-shell toner, in which the surface of the core particles is coated with a shell resin, differing from the resin constituting the core particles.

When forming the core-shell structure toner, the toner is constituted of a core particle resin which exhibits a low glass transition point to meet the required low temperature fixability, and of a shell resin which exhibits a high glass transition point to meet the required aggregation resistance.

In a core shell structure toner, to allow the conditions of Formula (2) regarding the above (Ta−Tg) to be satisfied, the following methods are exemplified: (1) a method of increasing the difference in glass transition point between a resin constituting the core and a resin constituting the shell; (2) a method of forming a thin shell of a uniform film thickness; (3) a method of completely coating the core particles with a shell; and (4) a method of increasing the difference between the molecular weight Mw1 of the resin constituting the core and the molecular weight Mw2 of the resin constituting the shell.

Targeted roles of a shell are described as follows: until a toner is transferred onto a transfer medium, the shell continues to completely coat the core resin, which exhibits a low glass transition point, to prevent the core resin from coming out of the shell of the toner, resulting in meeting the required aggregation resistance of the toner; in contrast, when the toner is fixed to the transfer medium, the shell cracks easily, which allows the core resin, exhibiting a low glass transition point, to totally migrate form the interior of the toner, so that the core resin promptly penetrates into the transfer medium, whereupon a state is realized in which the shell resin, exhibiting a high glass transition point, coats image surfaces; and as a result, the toner is capable of exhibiting low temperature fixability, and durability of fixed images against rubbing is enhanced.

The methods, corresponding to above (1)-(4), are detailed below.

(1) The relationship between the glass transition point Tg1 of the resin constituting core particles and the glass transition point Tg2 of the resin constituting a shell satisfies relationship Tg1<Tg2, but a difference of at least 20° C. is preferable. By allowing the difference to be at least 20° C., both the resin exhibiting a low glass transition point and the resin exhibiting a high glass transition point play a specific role. Therefore, it is possible for the toner to exhibit both low temperature fixability and aggregation resistance more satisfactorily.

(2) Since characteristics expected of a shell during fixing a toner are that the shell cracks easily and enables the core resin, present in the toner interior, to emerge easily, it is preferable to design a thin and uniform shell to coat the core particles. It is also preferable that the film thickness of the shell be in the range of 100-300 nm in order for the shell to be thin and to coat the core particles completely. With respect to uniform thickness, it is preferable that (Hmax/Hmin) be less than 1.5, wherein Hmax represents the maximum film thickness of the shell and Hmin represents the minimum film thickness thereof. When this value is less than 1.5 and the film thickness is uniform, the state of cracking of the shell becomes uniform, and then elution of the core resin is facilitated rapidly, as well as uniformly in the eluting areas, resulting in realization of low temperature fixability of the toner.

(3) To further enhance the effects described in (2), it is necessary to coat core particles, exhibiting a low glass transition point, with a shell. Even if only a portion of the core particles become exposed on the toner surface, the core resin, exhibiting a low glass transition point, is eluted from the exposed areas due to heat and stress, resulting in aggregation of the toner.

(4) It is conceivable that when a molecule featuring a long molecular chain penetrates into the fixed image surfaces by enlarging the molecular weight of a shell resin, compared to the molecular weight of a core resin, the toner exhibits low temperature fixability and high durability of fixed images against rubbing, even if the glass transition point of the toner is low. Therefore, it is preferable that (Mw2−Mw1) be at least 10,000.

Since the state of shell formation has not been specifically controlled, as described above, with respect to a toner of a conventional core-shell structure, in cases when lowering the glass transition point of the toner, it has been impossible to obtain a toner exhibiting low temperature fixability and high durability of fixed images against rubbing, as well as exhibiting a high aggregation resistance required for long-run printing.

In addition, the features of the toner of the present invention are that from the viewpoint of low temperature fixability, the glass transition point of the toner is in the range of 20-40° C., but preferably 25-35° C.; and from the viewpoint of realizing high image quality, the particle diameter of the toner is preferably in the range of 3-8 μm, but more preferably 4-6 μm.

### Glass Transition Point Tg of a Toner

Measurement of the glass transition point of a toner is carried out using a differential scanning calorimeter DSC-7 (produced by PerkinElmer, Inc.) and a thermal analysis controller TAC7/DX (produced by PerkinElmer, Inc.).

Measurement procedures are as follows:

The toner, weighing 4.5-5.0 mg, is precisely determined to two decimal places. The resultant sample is sealed in an aluminum pan (Kit No. 0219-0041) and placed in a DSC-7 sample holder. An empty aluminum pan is used for the reference measurement. Subsequently, heating-cooling-heating temperature control is carried out over a temperature range of 0-200° C., at a temperature increasing rate of 10° C./minute and a temperature decreasing rate of 10° C./minute. Analysis is performed based on data obtained during the second heating stage.

A glass transition point Tg is obtained as a value which is read at the intersection of the extension of the base line, prior to the initial rise of the first endothermic peak, with the tangent showing the maximum inclination between the initial rise of the first peak and the peak summit.

Further, according to the present invention, it is possible to calculate a theoretical glass transition point as the calculated method of the glass transition point. Herein, the theoretical glass transition point is calculated as follows: when constituents of a copolymer resin each form their respective homopolymers, the individual values of the glass transition point of the homopolymers are multiplied by the corresponding composition weight fractions, wherein, that is, the weighted average value is calculated. In other words, the theoretical glass transition point Tg (while the absolute temperature glass transition point is referred to as Tg′) is calculated by following Formula (6) using the glass transition points of the homopolymers which are formed from constituents constituting a copolymer resin.

1/Tg′=W1/T1+W2/T2+ . . . +Wn/Tn Formula (6)

(wherein W1, W2, . . . Wn are the weight fractions of the individual polymerizable monomers to all of the polymerizable monomers constituting the copolymer resin; and T1, T2, . . . Tn are the glass transition points (absolute temperature) of the homopolymers formed from the individual polymerizable monomers).

### 50% Aggregation Temperature Ta of a Toner

A 50% aggregation temperature of a toner is the testing temperature at which the aggregation rate is 50% in the following aggregation rate test.

In an aggregation rate test, 0.5 g of a toner sample is placed in a 10 ml glass bottle having a 21 mm inner diameter, and the lid is closed. The covered bottle is shaken 600 times using tap denser KYT-2000 (produced by Seishin Enterprise Co., Ltd.), followed by being allowed to stand, in the state of being uncovered, under an ambience of 35% RH for two hours at each of regular interval temperatures of 2.5° C. ranging from 30-80° C. Subsequently, the toner sample is placed onto a 48 mesh (open area: 350 μm) sieve with enough care so that the toner aggregate is not pulverized, and then set in a powder tester (produced by Hosokawa Micron Corp.), followed by being fixed with a presser bar and a knob nut to set shaking intensity at a sliding width of 1 mm. The rate (weight %) of the amount of the residual toner on the sieve is measured after 10 seconds of shaking.

Then, the toner aggregation rate is calculated by the following formula:

Toner aggregation rate (%)=(weight (g) of the residual toner on a sieve)/0.5 (g)×100

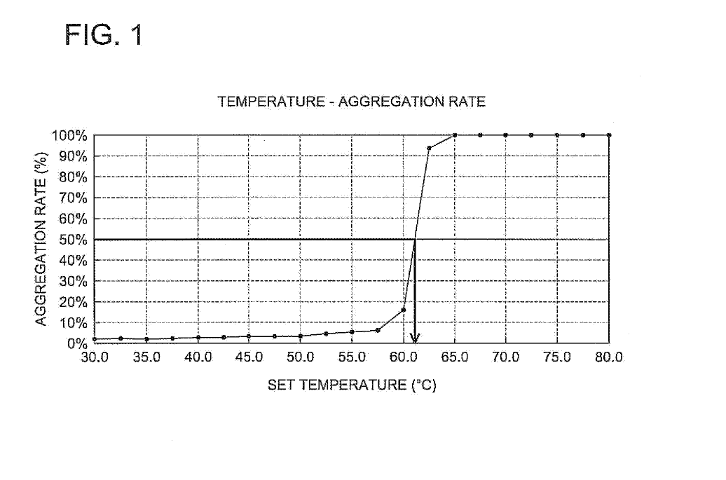

Specifically, as shown in FIG. 1, two points of the aggregation rates in the temperature range before and after the toner aggregation rate reaches 50% are connected with a straight line, and then a temperature (a 50% aggregation temperature), corresponding to the ratio of 50% on the straight line, is obtained.

It is preferable that the toner of the present invention satisfies following Formulas (3) and (4):

25≦Tg≦35 (° C.) Formula (3)

20≦(Ta−Tg)≦35 (° C.) Formula (4)

By satisfying these conditions, it is possible to positively achieve the targeted effects.

Further, in cases in which the toner of the present invention is a toner particle having a core-shell structure, it is easy to satisfy conditions for Tg and Ta by allowing the glass transition point Tg1 (° C.) of the resin constituting the core particles to be lower than the glass transition point Tg2 (° C.) of the resin constituting the shell.

In the present invention, it is preferable that the absolute value of the difference between a solubility parameter SP1 of the resin constituting the core particles and a solubility parameter SP2 of the resin constituting the shell be within the range of 0.32-1.12; the average film thickness of the shell be 100-300 nm when measured at eight random points; (Hmax−Hmin) be less than 1.50, wherein the maximum film thickness of the shell is Hmax and the minimum film thickness thereof is Hmin; and the shell completely coats the core particles so that no portions of the surface thereof is exposed.

### (Production Method of Toners)

The toner of the present invention readily and totally satisfies the above conditions by allowing the core particles to have a core-shell structure, as well as by allowing the shell to be prepared in the formation state, as described above. To prepare the core-shell toner, the following methods are exemplified.

### (A Uniformly Thin Shell)

By allowing the average film thickness of the shell to be 100-300 nm, as well as by allowing the ratio (Hmax/Hmin) of the maximum film thickness of the shell and the minimum film thickness thereof to be less than 1.50, a toner having the core-shell structure achieving the targeted effects is obtained. Herein, the film thickness of the shell may be verified via actual measurement.

### (Production Method of a Uniform Shell)

Controlling factors for forming the shell are exemplified as follows: (1) the glass transition points and the solubility parameters of resins constituting the core particles and the shell, (2) the circularity of the core particles, and (3) the temperature parameters for forming the shell.

Of these three factors, with respect to the glass transition points and the solubility parameters of the resins constituting the core particles and the shell, it is preferable to create a state in which the core particles and the shell each are not compatible. Specifically, by selecting appropriate resins used for constituting the core particles and the shell, a toner is obtained which features a structure in which a distinct boundary is formed via phase separation at the interface of the core particles and of the shell. In such a toner, even if the film thickness of the shell is low, the surface of the core particles is not exposed, resulting in forming a toner exhibiting excellent heat-resistant storage properties.

Since the specific surface area of core particles is small and the surface thereof becomes uniform by allowing the circularity (namely the spheroidicity) of the core particles to be high, it becomes easy that fine particles of a resin, constituting a shell, uniformly adhere to the core surfaces, resulting in easy formation of a toner having a shell of a uniform thickness.

The formation of the shell is carried out by allowing shell resin particles to adhere to the surfaces of the core particles. Under conditions for forming such a shell, in which, for example, the ambient temperature for forming the shell is allowed to be higher than the glass transition point Tg1 of the resin constituting the core particles, as well as to be lower than the softening point Tsp of the resin constituting the core particles, the shell resin particles certainly adhere well to the core surface. In this way, by allowing the ambient temperature to serve in ensuring adhesion of the shell resin particles to the surface of the core particles, the fine resin particles adhere to and accumulate uniformly on the surface of the core particles, resulting in forming a shell of the desired uniform thickness.

### (Production Method of a Shell of Uniform Film Thickness)

To form a uniform shell on the surface of a core exhibiting a low glass transition point Tg1, the following methods (1)-(3) are exemplified.

(1) A method of increasing the difference in glass transition point between a resin constituting the core particles and a resin constituting the shell, as well as of increasing the difference in solubility parameters of these resins.

When the glass transition point of the resin constituting the core particles is Tg1 and that of the resin constituting the shell is Tg2, it is preferable that Tg1 and Tg2 satisfy the relationship: (Tg2−Tg1)≧20 (° C.). However, it is more preferable to satisfy the relationship: (Tg2−Tg1)≧30 (° C.).

When the solubility parameter of the resin constituting the core particles is SP1 and that of the resin constituting the shell is SP2, it is preferable that the difference (ASP) between SP1 and SP2 be 0.19-1.12 as an absolute value, but is more preferably 0.32-1.12.

The solubility parameter of each of the core resin and the shell resin of a toner is determined from the composition of the resins constituting the above resins.

The solubility parameter of each constituent resin is calculated by multiplying the solubility parameter of each monomeric substance (also referred to as “monomer”), constituting the resin, by the mole ratio of the monomer. For example, provided that a copolymer resin is composed of two kinds of monomers of X and Y, when the weight composition ratios, the molecular weights, and the solubility parameters of both of the monomers are x and y (% by weight), Mx and My, and SPx and Spy, respectively, each of the monomer ratios is represented by x/Mx and y/My. Herein, when the mole ratio of the copolymer resin is C, C is represented by the following relationship: C=x/Mx+y/My. The solubility parameter Sp of this copolymer resin is represented by following Formula (7).

SP=((x×SPX/Mx)+(y×SPy/My))×1/C Formula (7)

The solubility parameter (SP value) of a monomer is determined as follows.

A solubility parameter (SP value) v of a monomer A is calculated by Formula (8), described below, by calculating the evaporation energy (Δei) and the molar volume (Δvi) with respect to the atomic groups in the molecular structure of the monomer, by referring to the method proposed by Fedors, described in “Polym. Eng. Sci., Vol. 114, p 114 (1974).”

However, with respect to a monomer having a double bond, which is cleaved during polymerization, the cleaved state is regarded as its molecular structure.

v=(ΣΔei/ΣΔvi)^{1/2} Formula (8)

The values, calculated via the above method, are employed as the solubility parameters of the following monomers.

| | |
|---|---|
| Styrene | 10.55 |
| Butyl acrylate | 9.77 |
| 2-Ethyl hexyl methacrylate | 9.04 |
| 2-Ethyl hexyl acrylate | 9.22 |
| Methyl methacrylate | 9.93 |
| Methacrylic acid | 12.54 |
| Acrylic acid | 14.04 |

Using these values, the solubility parameter of a copolymer is calculated based on Formula (7). Further, in cases in which it is impossible to calculate the solubility parameter of a monomer using the calculating formula represented by Formula (8), it is recommended to obtain a specific value by referring to publications such as “Polymer Handbook, Vol. 4” (published by John Wily and Sons, Inc.), as well as to the solubility parameter section (http://polymer.nims.go.jp/guide/guide/p5110.html) described in “PolyInfo” (http://polymer.nims.go.jp), which is a database provided by the National Institute for Materials Science.

With respect to the toner of the present invention, when the difference ΔSP=|SP2−SP1| between a solubility parameter (SP1) of the core of the toner and a solubility parameter (SP2) of the shell, most distant from the solubility parameter of the core, among the solubility parameters of resins constituting the shell, is 0.19-1.12, but is more preferably 0.32-1.12, each of the sites of the toner exhibits appropriate adhesion force and stable non-compatibility, and also any wax, contained in the toner, tends not to move toward the toner surface except during fixing, resulting in realizing high image durability.

The solubility parameter of each resin is controllable by appropriately selecting the type and the ratio of the polymerizable monomer constituting the copolymer. It is specifically preferable to control the solubility parameter by the acid monomer content.

It is further preferable that the solubility parameter of the shell resin forming the outermost layer be higher than that of the resins constituting the core particles and that of each shell except the one forming the outermost layer. The reason for this is that during toner preparation, the process of forming a shell is preferably accomplished, and also the shell is prepared in a short time, whereby a toner of the desired form is readily obtained.

(2) A Method of Forming a Shell After Improving Spherical Properties of Core Particles

It is preferable to initiate shell formation after increasing the circularity of the core particles to be at least 0.900.

(3) A Method of Ensuring Appropriate Shell Formation Temperature

It is preferable that the shell formation temperature be at least 20° C. higher than the glass transition point Tg1 of a resin constituting the core particles, as well as being lower than the softening point Tsp of a resin constituting the core particles.

Further, the specific production method of the toner of the present invention is described below.

The toner of the present invention is prepared, for example, via the following processes: (1) a dissolution/dispersion process in which releasing agents are dissolved in or dispersed into radically polymerizable monomers, (2) a polymerization process in which a dispersion of fine resin particles is prepared, (3) an aggregation-fusion process in which core particles (being associated particles) are obtained by aggregating and fusing the fine resin particles and colorant particles in an aqueous medium, (4) a first ripening process in which the form of the associated particles is controlled by ripening employing thermal energy, (5) a shell formation process in which colored particles, having a core-shell structure, are formed by adding shell resin particles into the core particle dispersion and by allowing the shell resin particles to aggregate and fuse onto the surfaces of the core particles, (6) a second ripening process in which the form of the colored particles having a core-shell structure is controlled by ripening the colored particles having the core-shell structure employing thermal energy, (7) a washing process in which the colored particles are subjected to solid-liquid separation from the cooled colored particle dispersion and surfactants are removed from the colored particles, and (8) a drying process in which the washed colored particles are dried.

Further, after the drying process, (9) a process, in which any appropriate external additives are added to the dried colored particles, is also applied, if appropriate. Each of these processes is further detailed afterward.

Initially, when producing the toner of the present invention, core particles are produced via an association fusion process applied to fine resin particles and colorant particles. Subsequently, shell resin particles are added to a core particle dispersion, and the surface of the core particles is coated with the shell resin particles by aggregating and fusing the latter to prepare the colored particles having a core-shell structure. In this way, a toner having a core-shell structure is prepared by fusing core particles to resin particles, in which the resin particles are added to the core particle dispersion, which has been prepared via appropriate production methods.

One feature of the toner of the present invention is that the shell is extremely thin and the film thickness thereof is uniform. After shell formation, it is preferable that the particle diameter be constant and the shape be uniform. To prepare a toner having such a structure and shape, the shell formation is conducted by adding shell resin particles to core particles, having been prepared so as to exhibit extremely narrow-size distribution and a uniform shape. Further, the toner is controlled to the targeted shape via shape control during shell formation, but specifically, it is most important to prepare and utilize core particles having a uniform particle diameter and uniform shape. Fine shell resin particles are capable of uniformly adhering to such core particles, resulting in a toner exhibiting an extremely uniform film thickness.

Core particles constituting a toner are prepared via a method of aggregating and fusing fine resin particles and colorant particles. The shape of the core particles is controlled, for example, via control of heating temperature in an aggregation fusion process, as well as of the heating temperature and duration in a first ripening process.

Of these factors, duration control in the first ripening process is the most effective. Since the purpose of the ripening process is to control the circularity of associated particles, the targeted circularity is achieved via control of this ripening duration.

Core particles constituting a toner are preferably prepared, for example, by employing the following method: a releasing agent constituent is dissolved in or dispersed into a polymerizable monomer forming resin (A), followed by mechanically dispersing the resulting product to prepare fine particles dispersed in an aqueous medium; and fine complex resin particles and colorant particles, having been formed by polymerizing the polymerizable monomer via a mini-emulsion polymerization method, are salted out and fused, as described below. To dissolve a releasing agent constituent in a polymerizable monomer, the releasing agent constituent may be dissolved not only via dissolution but also by melting.

Each of the production processes of the present invention is described below.

(1) Dissolution/Dispersion Process

This process is one which prepares a solution of a radically polymerizable monomer, mixed with a releasing agent compound, by dissolving the releasing agent compound in the radically polymerizable monomer.

(2) Polymerization Process

In one appropriate example of this polymerization process, a radically polymerizable monomer solution, containing a dissolved or dispersed wax (namely a releasing agent), is added to an aqueous medium containing a surfactant at a concentration being at most its critical micelle concentration (CMC), followed by forming droplets via application of mechanical energy, and subsequently, a polymerization reaction is performed in the droplets via addition of a water-soluble radical polymerization initiators. An oil soluble polymerization initiator may be contained in the droplets. In such a polymerization process, it is essential to form the droplets by a forced emulsifying treatment via application of mechanical energy. Examples of such a method of applying mechanical energy include methods of application of strong agitation or ultrasonic vibration energy using a homomixer, ultrasonic waves, or a Manton-Gaulin homogenizer.

In this polymerization process, fine resin particles incorporating a wax and a binding resin are obtained. The fine resin particles may be not only colored fine particles but also uncolored fine particles. The colored fine particles are obtained by polymerizing a monomer composition incorporating a colorant. Further, in cases when employing the uncolored fine particles, colored particles are obtained by fusing fine resin particles with colorant particles via addition of a colorant particle dispersion to a fine resin particle dispersion in an aggregation-fusion process, described below.

(3) Aggregation•Fusion Process

With respect to an aggregation and fusion method in a fusion process, a salting-out/fusion method using fine resin particles (being colored or uncolored fine resin particles) having been obtained in the polymerization process, is preferably employed. Further, in the aggregation-fusion process, it is possible to aggregate and fuse fine internal additive particles such as fine releasing agent particles and charge controlling agents, together with the fine resin particles and the colorant particles.

In addition, “salting-out” described herein means that when particles grow to the desired particle diameter via the concurrent processing of aggregation and fusion, particle growing is terminated by adding an aggregation terminating agent, followed by applying continued heating to control the particle shape, as appropriate.

“An aqueous medium” in the aggregation•fusion process refers to a medium, which contains water amounting to at least 50% by weight as the main constituent. Herein, examples of the constituents except water include organic solvents soluble in water such as methanol, ethanol, isopropanol, butanol, acetone, methyl ethyl ketone, and tetrahydrofuran.

The colorant particles are prepared by dispersing a colorant in an aqueous medium. The dispersion treatment of the colorant is carried out in the state in which the concentration of a surfactant in water remains to be at least its critical micelle concentration (CMC). Dispersion apparatuses employed for dispersing the colorants are not specifically limited. However, preferred examples thereof include an ultrasonic dispersion apparatus, a mechanical homogenizer, a pressure dispersion apparatus such as a Manton-Gaulin homogenizer, a pressure type homogenizer, a sand grinder, a medium type dispersion apparatus such as a Getzmann mill and a diamond fine mill. Further, surfactants utilized include the same type of the above surfactant.

In addition, the colorant (being the fine particles) may be surface-modified. The surface-modification method for the colorant is conducted as follows: the colorant is dispersed in a solvent, and a surface modifier is added to the dispersion, followed by conducting reaction of this system via elevating temperature. After the reaction, the colorant is filtered, and washing filtration is repeated with the same solvent, followed by drying the residue to obtain the colorant (being the pigment), having been treated with the surface modifier.

A salting-out/fusion method, being a preferred aggregation and fusion method, is performed as follows: a salting-out agent, composed of an alkali metal salt, an alkaline earth metal salt, or a trivalent salt, serving as an aggregating agent at a concentration being at least its critical aggregation concentration, is added to water containing fine resin particles and colorant particles, followed by conducting fusion and salting-out concurrently via heating up to at least the glass transition point of the fine resin particles, as well as up to the melting peak temperature (° C.) of the mixture. Herein, examples of the alkali metal salt and the alkaline earth metal salt as a salting-out agent include lithium, potassium, and sodium as the alkali metal salt, and magnesium, calcium, strontium, and barium as the alkaline earth metal salt. Of these, potassium, sodium, magnesium, calcium, and barium are preferred.

In cases in which aggregation and fusion are carried out via salting-out/fusion, it is preferable to allow the standing duration after the addition of a salting-out agent to be as short as possible. Although the reason is not clear, there occur problems that the aggregation state of particles varies; the particle diameter distribution becomes unstable; and surface properties of a fused toner vary, depending on the standing duration after salting-out. Further, it is necessary to allow the temperature for adding the salting-out agent to be equal to or less than the glass transition point of the fine resin particles at least. The reason is that when the temperature for adding the salting-out agent is at least the glass transition point of the fine resin particles, it is impossible to control the particle diameter, although salting-out/fusion of the fine resin particles rapidly proceeds, resulting in causing such a problem that particles having a large particle diameter are created. Although the temperature range of this addition may be at most the glass transition point of the resin, it is common to be 5-55° C., but preferably 10-45° C.

Further, the salting-out agent is added at a temperature being at most the glass transition point of the fine resin particles, followed by elevating temperature, as soon as possible, up to a temperature being at least the glass transition point of the fine resin particles, as well as being at least the melting peak temperature of the above mixture. It is preferable that the time required for elevating temperature be less than an hour. Further, the rapid temperature elevation is necessary, but it is preferable that the elevating rate be at least 0.25° C./min. The upper limit for the elevating rate is not specifically definite, but it is preferable to be at most 5° C./min due to a problem of the difficulty in controlling the particle diameter since salting-out is carried rapidly due to instantaneous temperature elevation. In this fusion process, associated particles, that is, a core particle dispersion, incorporating the salted out/fused fine resin particles and fine optional particles, is obtained.

(4) First Ripening Process

Subsequently, the surface of the core particles, having been formed to have constant and narrow distribution of the particle diameter, is controlled so as to have a smooth but uniform shape by controlling heating temperature in the aggregation-fusion process, specifically, by controlling heating temperature and duration in a first ripening process. Specifically, uniformalization is facilitated by setting heating temperature at a low temperature in the aggregation•fusion process, in which self-fusion process of the particles is controlled, and also while the surface of the core particles is allowed to be of a uniform shape by setting heating temperature at a low temperature, as well as by prolonging the process duration in the first ripening process, the circularity of the core particles is controlled so as to be at least 0.90.

(5) Shell Formation Process

In a shell formation process, a shell resin particle dispersion is added to a core particle dispersion to allow the shell resin particles to aggregate and fuse on the surface of the core particles, and further to coat the surface of the core particles, whereby a core-shell structure is formed.

Specifically, the shell resin particle dispersion is added to the core particle dispersion, while the temperatures in the aggregation-fusion process and the first ripening process are kept, and thereafter colored particles, having the surface coated with the shell resin particles, are formed, in which the coating process proceeds slowly over several hours via the continuous application of heating and agitation. Herein, the heating and agitation duration is preferably in the range of 1-7 hours, more preferably 3-5 hours.

(6) Second Ripening Process

When the particle diameter of the colored particles reaches the predetermined one during shell formation, the particle growing process is terminated by adding a stopping agent such as sodium chloride, but furthermore the heating and agitation are continued for several hours to fuse the shell resin particles, which have adhered to the core particles. Consequently, a shell of a 100-300 nm thickness is formed on the surface of the core particles in the shell formation process. In this way, via the shell formation which allows the resin particles to adhere to the surface of the core particle, the roundish and moreover uniform colored particles are formed.

According to the present invention, it is possible to control the shape of the colored particles so as to become a nearly spherical form by setting duration to be long and by setting the ripening temperature to be high in the second ripening process.

(7) Cooling Process•Solid-Liquid Separation•Washing Process

This process is one in which the colored particle dispersion is cooled (rapidly cooled). In the cooling treatment, the cooling rate is in the range of 1-20° C./min. Methods of the cooling treatment, although not specifically limited, may include a method of cooling via feeding a cooling medium from the exterior of the reaction vessel, and a method of cooling by directly placing chilled water into the reaction system.

In this solid-liquid separation•washing process, the following treatments are applied: a solid-liquid separation treatment of separating the colored particles from the colored particle dispersion, which has been cooled down to a predetermined temperature in the above process, and a washing treatment of removing deposits such as the surfactant and the salting-out agent from a toner cake (being an accumulated substance of a cake-shape formed by aggregating the colored particles in a wet state) obtained via the solid-liquid separation. Herein, filtration methods include a centrifugal separation method, a vacuum filtration method carried out employing a Buchner funnel, and a filtration method carried out employing a filter press, but the filtration methods are not specifically limited.

(8) Drying Process

This process is one in which the washed toner cake is dried to prepare dried colored particles. Examples of driers employed in this process include spray driers, vacuum freeze driers, and vacuum driers. It is preferable to employ any of the stationary tray drier, transportable tray drier, fluid layer drier, rotary type drier, and stirring type drier. The moisture in the dried colored particles is preferably at most 5% by weight, but is more preferably at most 2% by weight. In addition, when the dried colored particles are aggregated via weak attractive force among themselves, the aggregates may be pulverized. Herein, mechanical pulverizing apparatuses such as a jet mill, a HENSCHEL mixer, a coffee mill, or a food processor may be employed as a pulverizing method.

(9) External Additive Treatment Process

This process is one in which a toner is prepared, if appropriate, by mixing external additives in the dried colored particles.

Mechanical mixers such as a HENSCHEL mixer or a coffee mill may be employed as a mixer for the external additives.

It is preferable that the weight average particle diameter (namely the variance particle diameter) be in the range of 10-1,000 nm, but more preferably 30-300 nm.

This weight average particle diameter is determined with electrophoretic light scattering spectrophotometer “ELS-800” (produced by Otsuka Electronics Co., Ltd.). (Toner Materials Utilized in the Present Invention)

(1) Binding Resins

It is preferable that Resin A constituting the core particles as well as Resin B constituting the shell be styrene-acryl based copolymer resins. Further, it is preferable that a monomer, used for preparing a resin constituting the core particles, be a polymerizable monomer, exhibiting the characteristic of decreasing the glass transition point of a copolymer to be obtained, such as propyl acrylate, propyl methacrylate, butyl acrylate, or 2-ethylhexyl acrylate. Further, it is preferable that a monomer, used for preparing a resin constituting the shell, be a polymerizable monomer, exhibiting the characteristic of increasing the glass transition point of a copolymer to be obtained, such as styrene, methyl methacrylate, or methacrylic acid.

Resins constituting the toner of the present invention are further detailed.

As the resins constituting the core particles and the shell of the toner of the present invention, polymers, obtained by polymerizing the following polymerizable monomers, are utilized.

The resins incorporate polymers, obtained by polymerizing at least one kind of polymerizable monomer, as constituent compositions. The polymerizable monomer includes styrene or styrene derivatives such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, or p-n-dodecylstyrene; methacrylate derivatives such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, diethylaminoethyl methacrylate, or dimethylaminoethyl methacrylate; acrylate derivatives such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, or phenyl acrylate; olefins such as ethylene, propylene, or isobutylene; halogen based vinyls such as vinyl chloride, vinylidene chloride, vinyl bromide, vinyl fluoride, or vinylidene fluoride; vinyl esters such as vinyl propionate, vinyl acetate, or vinyl benzoate; vinyl ethers such as vinyl methyl ether or vinyl ethyl ether; vinyl ketones such as vinyl methyl ketone, vinyl ethyl ketone, or vinyl hexyl ketone; N-vinyl compounds such as N-vinylcarbazole, N-vinylindole, or N-vinylpyrrolidone; vinyl compounds such as vinylnaphthalene or vinylpyridine; and acrylic or methacrylic derivatives such as acrylonitrile, methacrylonitrile, or acrylamide. These vinyl based monomers may be employed individually or in combination.

Furthermore, as a polymerizable monomer constituting the resins, it is further preferable to employ combinations of those having an ionic dissociating group. Examples thereof include ones which have a substituent such as a carboxyl group, a sulfonic acid group, or a phosphoric acid group as a constituent group of the monomer. Specific examples include acrylic acid, methacrylic acid, maleic acid, itaconic acid, cinnamic acid, fumaric acid, monoalkyl maleate, monoalkyl itaconate, styrene sulfonic acid, allylsulfosuccinic acid, 2-acrylamido-2-methylpropanesulfonic acid, acid phosphoxyethyl methacrylate, and 3-choro-2-acid phosphoxypropyl methacrylate.

Further, it is also possible to produce crosslinking structured resins employing polyfunctional vinyls such as divinylbenzene, ethylene glycol methacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, or neopentyl glycol diacrylate.

(2) Colorants

It is possible to employ any of carbon blacks, magnetic substances, dyes, or pigments as the colorant of the present invention. Examples of the carbon blacks include channel black, furnace black, acetylene black, thermal black, and lamp black. It is possible to employ as the magnetic substance, ferromagnetic metals such as iron, nickel, or cobalt; alloys containing these metals; ferromagnetic metal compounds such as ferrite or magnetite; alloys, which contains no ferromagnetic metals, capable of exhibiting ferromagnetism via a heat treatment, such as Heusler alloys, for example, manganese-cupper-aluminum, or manganese-cupper-tin; and chromium dioxide.

It is possible to employ, as the dye, C.I. Solvent Red 1, C.I. Solvent Red 49, C.I. Solvent Red 52, C.I. Solvent Red 58, C.I. Solvent Red 63, C.I. Solvent Red 111, C.I. Solvent Red 122, C.I. Solvent Yellow 19, C.I. Solvent Yellow 44, C.I. Solvent Yellow 77, C.I. Solvent Yellow 79, C.I. Solvent Yellow 81, C.I. Solvent Yellow 82, C.I. Solvent Yellow 93, C.I. Solvent Yellow 98, C.I. Solvent Yellow 103, C.I. Solvent Yellow 104, C.I. Solvent Yellow 112, C.I. Solvent Yellow 162, C.I. Solvent Blue 25, C.I. Solvent Blue 36, C.I. Solvent Blue 60, C.I. Solvent Blue 70, C.I. Solvent Blue 93, and C.I. Solvent Blue 95, further including mixtures thereof. It is possible to employ, as the pigment, C.I. Pigment Red 5, C.I. Pigment Red 48:1, C.I. Pigment Red 53:1, C.I. Pigment Red 57:1, C.I. Pigment Red 122, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222, C.I. Pigment Orange 31, C.I. Pigment Orange 43, C.I. Pigment Yellow 14, C.I. Pigment Yellow 17, C.I. Pigment Yellow 93, C.I. Pigment Yellow 94, C.I. Pigment Yellow 138, C.I. Pigment Yellow 156, C.I. Pigment Yellow 158, C.I. Pigment Yellow 180, C.I. Pigment Yellow 185, C.I. Pigment Green 7, C.I. Pigment Blue 15:3, and C.I. Pigment Blue 60, further including mixtures thereof. Although the number average primary particle diameter varies depending on the type, it is preferable to be approximately in the range of 10-200 nm.

With respect to a method of adding a colorant, the colorant is added at the stage in which fine resin particles are aggregated by adding an aggregating agent, resulting in coloring a resultant polymer. In addition, it is possible to utilize a colorant whose surface has been treated with a coupling agent.

(3) Waxes (Releasing Agents)

Waxes are usable for the toner of the present invention. Such waxes include those known in the art. Specific examples thereof include polyolefin waxes such as polyethylene wax or polypropylene wax; long chain hydrocarbon based waxes such as paraffin wax or sasol wax; dialkyl ketone based waxes such as distearyl ketone; ester based waxes such as carnauba wax, montan wax, trimethylolpropane tribehenate, pentaerythritol tetramyristate, pentaerythritol tetrastearate, pentaerythritol tetabehenate, pentaerythritol diacetate dibehenate, glycerin tribehenate, 1,18-octadecanediol distearate, tristearyl trimelliate, or distearyl maleate; and amide based waxes such as ethylenediaminebehenylamide, or trimellitic acid tristearylamide.

The melting point of the wax is commonly in the range of 40-160° C., preferably 50-120° C., more preferably 60-90° C. By allowing the melting point to be within the range, heat resistance shelf life of a toner is secured, as well as stable toner images are formed in which no cold offsetting occurs even during low temperature fixing. Further, a wax content in the toner is preferably in the range of 1-30% by weight, but being more preferably in the range of 5-20% by weight.

Polymerization initiators, chain transfer agents, and surfactants, usable in the production method of a toner, will now be described.

(4) Radical Polymerization Initiators Usable in the Present Invention

Resins constituting the core and shell, which constitute the toner of the present invention, are prepared by polymerizing the polymerizable monomers. Radical polymerization initiators, utilized in the polymerization, are as follows: azo or diazo based polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, or azobisisobutyronitrile; peroxide based polymerization initiators such as benzoyl peroxide, methyl ethyl ketone peroxide, diisopropyl peroxycarbonate, cumene hydroperoxide, t-butylhydro peroxide, di-t-butyl peroxide, dicumyl peroxide, 2,4-dichlorobenzoyl peroxide, lauroyl peroxide, 2,2-bis-(4,4-t-butylpeoxycyclohexyl)propane, or tris-(t-butylperoxy)triazine; and polymer initiators having a peroxide in the side chain.

Further, when an emulsion polymerization method is employed for forming resin particles, it is possible to utilize water-soluble radical polymerization initiators, which may include persulfates such as potassium persulfate or ammonium persulfate, as well as azobisaminodipropane acetate, azobiscyanovaleric acid or salts thereof, and hydrogen peroxide.

To control the molecular weight of resins constituting the complex resin particles, a chain transfer agent, which is commonly utilized, is employable.

The chain transfer agent is not specifically limited, including, for example, mercaptans such as octyl mercaptan, dodecyl mercaptan or tert-dodecyl mercaptan; n-octyl-3-mercaptopropionate; terpinolene; carbon tetrabromide, and α-methylstyrene dimer.

(5) Dispersion Stabilizers

Further, to keep a polymerizable monomer dispersed appropriately in a reaction system, dispersion stabilizers may be employed. The dispersion stabilizers include tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina. Further, it is possible to employ commonly used surfactants such as polyvinyl alcohol, gelatin, methyl cellulose, sodium dodecylbenzenesulfonate, ethylene oxide adducts, or sodium higher fatty alcohol sulfate as the dispersion stabilizer.

Surfactants utilized in the present invention will now be described.

To carry out polymerization using the radically polymerizable monomer, it is necessary to form an oil droplet dispersion in an aqueous medium using a surfactant. The surfactant is not specifically limited; however, preferred examples include the following ionic surfactants.

Exemplified are sulfonates (for example, sodium dodecylbenzenesulfonate, sodium aryl alkyl polyethersulfonate, sodium 3,3-disulfondiphenylurea-4,4-diazo-bis-amono-8-naphthol-6-sulfonate, sodium ortho-caboxybenzene-azo-dimethylaniline-2,2,5,5-tetramethyl-triphenylmethane-4,4-diazo-bis-β-naphthol-6-sulfonate), sulfates (for example, sodium dodecylsulfate, sodium tetradodecylsulfate, sodium pentadodecylsulfate, sodium octylsulfate), and fatty acid salts (for example, sodium cleate, sodium laureate, sodium caprate, sodium caprylate, sodium caproate, potassium stearate, and potassium oleate).

Further, it is possible to employ nonionic surfactants. Specifically, it is possible to cite polyethylene oxide, polypropylene oxide, a combination of polypropylene oxide and polyethylene oxide, esters of polyethylene glycol and higher fatty acids, alkylphenol polyethylene oxide, esters of higher fatty acids and polyethylene glycol, esters of higher fatty acids and polypropylene oxide, and sorbitan esters.

### (Aggregating Agents)

In cases when producing toner particles constituting the toner of the present invention via a mini-emulsion polymerization aggregation method or an emulsion polymerization aggregation method, aggregating agents utilized to obtain the binding resins may include, for example, alkali metals and alkaline earth metals. The alkali metals constituting the aggregation agents include lithium, potassium, and sodium, and the alkaline earth metals constituting the aggregation agents include magnesium, calcium, strontium, and barium. Of these, potassium, sodium, magnesium, calcium, and barium are preferred. Counter ions (being anions constituting salts) of the alkali metals and the alkaline earth metals include chloride ions, bromide irons, iodide ions, carbonate ions, and sulfate ions.

### (Charge Control Agents)

Charge control agents may be incorporated in toner particles constituting the toner of the present invention, if beneficial. Various compounds known in the art may be employed as the charge control agents.

### (Average Circularity of Toner Particles)

From the viewpoint of improving transfer efficiency regarding individual toner particles constituting the toner of the present invention, it is preferable that the average circularity, represented by following Formula (9), of the toner be in the range of 0.930-1.000, more preferably 0.950-0.995.

Average circularity=(circumferential length of a circle obtained based on the circle equivalent diameter)/(circumferential length of the projected toner image) Formula (9)

### (External Additives)

To improve fluidity and chargeability, as well as to enhance cleaning properties, the toner of the present invention may be employed, into which so-called external additives are incorporated. The external additives are not specifically limited, and various types of fine inorganic particles, fine organic particles, and lubricants may be employed.

It is possible to preferably employ inorganic oxide particles such as silica, titania, or alumina, and further it is preferable that these fine inorganic particles has been subjected to hydrophobic treatment using a silane coupling agent or a titanium coupling agent. It is preferable that the number average primary particle diameter of the fine inorganic particles be 5-60 nm from the viewpoint of imparting fluidity to the toner. The degree of the hydrophobic treatment is not specifically limited, but is preferably 40-95 in terms of methanol wettability. Methanol wettability is a measure for evaluating the wettability to methanol, that is, 0.2 g of the fine inorganic particles to be measured is added to 50 ml of distilled water contained in a beaker having a capacity of 200 ml, and slowly stirred; and then by using a burette, whose end portion is dipped in the liquid, methanol is dropped until the entire fine inorganic particles are wetted. When the methanol quantity required for completely wetting the fine inorganic particles is denoted by a (ml), the degree of making hydrophobic is calculated from following Equation 1,

Degree of making hydrophobic (a/(a+50))×100. Equation 1

Still further, it is possible to utilize fine organic particles, which are spherical ones at a number average primary particle diameter of about 10-2,000 nm as the fine organic particles. Polymers such as polystyrene, polymethyl methacrylate, or styrene-methyl methacrylate copolymer may be employed for the fine organic particles.

The adding ratio of these external additives in the toner is commonly 0.1-5.0% by weight, but is preferably 0.5-4.0% by weight. Further, various external additives may be employed in combination.

### (Developers)

The toner of the present invention may be utilized as a magnetic or non-magnetic single component developer, and also as a two component developer by being blended with carriers. In cases when employing the toner of the present invention as the single component developer, it is possible to cite a non-magnetic single component developer or a magnetic single component developer which is prepared by incorporating magnetic particles of a size of about 0.1—about 0.5 μm into the toner. Either of them may be employed. Further, in cases when employing the toner of the present invention as the two component toner, it is possible to utilize, as the carriers, magnetic particles, composed of materials conventionally known in the art, including metals such as iron, ferrite, or magnetite, as well as alloys of the above metals with metals such as aluminum or lead, but ferrite particles are specifically preferred. Further, it is possible to utilize, as the carriers, coated carriers whose surfaces are coated with a coating agent such as a resin, or resin-dispersion type carriers, incorporating fine magnetic powders dispersed in the binder resin.

Coating resins constituting the coated carriers are not specifically limited. Examples thereof include olefin based resins, styrene based resins, styrene-acryl based resins, silicone based resins, ester based resins, and fluorine-containing polymer based resins. Further, resins constituting the resin dispersion type carriers are also not specifically limited, and any of those known in the art may be employed. Usable examples include styrene-acryl based resins, polyester resins, fluorine resins, and phenol resins.

Of these, preferable carries include coated carriers coated with styrene-acrylic resins from the viewpoints of minimizing the leaving of the external additives, as well as of realizing the targeted durability.

The volume average particle diameter of the carriers is preferably 20-100 μm, but is more preferably 25-80 μm. It is possible that the volume average particle diameter of the carriers is determined typically with laser diffraction type particle size distribution meter “HELOS” (produced by Sympatec GmbH), which is provided with a wet type homogenizer.

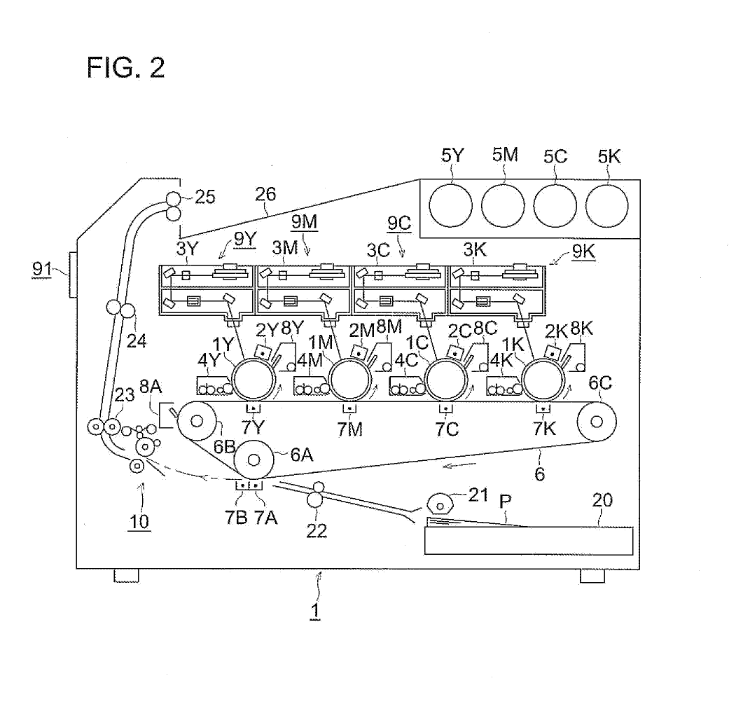

FIG. 2 is a schematic view showing an example of an image forming apparatus utilized in the present invention.

As shown in FIG. 2, an image forming apparatus 1 is a tandem system color image forming apparatus, structured in such a manner that plural groups of image forming units 9Y, 9M, 9C, and 9k, are arranged along with a belt type intermediate transfer medium 6, a paper feed member, a transportation member, toner cartridges 5Y, 5M, 5C, and 5K, as well as a fixing device 10 and an operating section 91 of the present invention.

The image forming unit 9Y, forming yellow images, is provided with a charging member 2Y, an exposing member 3Y, a developing device 4Y, a transfer member 7Y, and a cleaning member 8Y arranged on the outer circumference of an image support (hereinafter, referred to as a photoreceptor) 1Y.

The image forming unit 9M, forming magenta images, is provided with a photoreceptor 1M, a charging member 2M, an exposing member 3Y, a developing device 4M, a transfer member 7M, and a cleaning member 8M.

The image forming unit 9C, forming cyan images, is provided with a photoreceptor 1C, a charging member 2C, an exposing member 3C, a developing device 4C, a transfer member 7C, and a cleaning member 8C.

The image forming unit 9K, forming black images, is provided with a photoreceptor 1K, a charging member 2K, an exposing member 3K, a developing device 4K, a transfer member 7K, and a cleaning member 8K.

The intermediate transfer medium 6 is wounded around plural rollers 6A, 6B, and 6C, and held so as to rotate.

Images of each color, formed in the image forming units 9Y, 9M, 9C, and 9K, are primarily transferred singly onto the rotating intermediate transfer medium 6 by the transfer members 7Y, 7M, 7C, and 7K to form composite color images.

Paper sheets P stored in a paper feed cassette 20, as a paper feed member, are fed singly by a feed roller 21 and conveyed to a transfer member 7A through a registration roller 22, whereby the color images are secondarily transferred onto each of the paper sheets P.

The paper sheet P, on which the color images have been transferred, is subjected to fixing by the fixing device 10, being a fixing device of the present invention. After passing through transportation rollers 23 and 24 as transportation members, the paper sheet is clamped by a paper discharge roller 25, followed by being placed on a paper discharge tray 26 located outside the apparatus.

The transfer medium, employed in the present invention, is a support, which retains toner images, commonly called an image supporting medium, a recording medium, or transfer paper. Specific examples include various transfer media such as plain paper and bond paper being from thin to thick, coated printing paper such as art paper or coated paper, Japanese paper and postcard paper available on the market, OPS plastic films, and cloths; however being not limited thereto.

### EXAMPLES

The present invention will now be described with reference to examples; however, the present invention is not limited to these embodiments. Incidentally, “parts” in the following description represents “parts by weight”, unless otherwise specified.

### <Preparation of Core Resin Particle A1>

“Core Resin particle A1” having a multi-layered structure was prepared via a first stage polymerization, a second stage polymerization, and a third stage polymerization, as described below.

(1) First Stage Polymerization

A surfactant solution, prepared by dissolving 4 parts of an anion surfactant S represented by following Chemical Formula 1 in 3,040 parts of ion-exchanged water, was placed in a 5 l reaction vessel fitted with a stirrer, a thermal sensor, a cooling pipe, and a nitrogen introducing unit, and the internal temperature was elevated to 80° C. while stirring at 230 rpm under a nitrogen flow.

C₁₀H₂₁(OCH₂CH₂)₂SO₃Na (Chemical Formula 1)

An initiator solution, prepared by dissolving 10 parts of a polymerization initiator (potassium persulfate: KPS) in 400 parts of ion-exchanged water, was added to the surfactant solution, and the internal temperature was elevated to 75° C., followed by dripping a monomer mixture liquid containing 480 parts of styrene, 252 parts of n-butyl acrylate, 68 parts of methacrylic acid, and 15 parts of n-octyl mercaptan over an hour. Subsequently, polymerization (a first stage polymerization) was carried out by heating the system at 75° C. for two hours while stirring to prepare the resin particles, being referred to as “Resin Particle a1-1.”

The weight average molecular weight (Mw) of “Resin Particle a1-1”, prepared in the first polymerization, was 19,500.

(2) Second Stage Polymerization (Formation of an Intermediate Layer)

In a 5 l reaction vessel fitted with a stirrer, a thermal sensor, a cooling pipe, and a nitrogen introducing unit, 94 parts of paraffin wax “HNP-57” (produced by Nihon Seiro Co. Ltd.) as a releasing agent were added to a mixture liquid containing 91 parts of styrene, 72 parts of n-butyl acrylate, and 12 parts of methacrylic acid, followed by elevating the temperature to 80° C. to dissolve the resultant reaction mixture.

On the other hand, a surfactant solution, prepared by dissolving 3 parts of the anion surfactant S, being the same as described above, in 1,340 parts of ion-exchanged water, was heated to 80° C., and then 30 parts, in terms of a solid content, of a dispersion of Resin Particle a1-1 were added to the surfactant solution. Thereafter, the polymerizable monomer solution was mixed and dispersed for two hours using mechanical system homogenizer “CLEAR MIX” fitted with a circulatory path (produced by M Technique Co., Ltd.), whereby an emulsion liquid incorporating emulsified particles containing dispersion particles (260 nm) was prepared.

Subsequently, after adding 1,460 parts of ion-exchanged water, an initiator solution, prepared by dissolving 6 parts of the polymerization initiator (potassium persulfate) in 142 parts of ion-exchanged water, as well as 2 parts of n-octyl mercaptan were added, and the temperature was elevated to 80° C. Thereafter, polymerization (a second stage polymerization) was carried out by heating the system at 80° C. for three hours while stirring to prepare resin particles, being referred to as “Resin Particle a1-2.” The weight average molecular weight (Mw) of “Resin Particle a1-2”, prepared in the second stage polymerization, was 18,200.

(3) Third Stage Polymerization (Formation of an Outer Layer)

An initiator solution, prepared by dissolving 5 parts of potassium persulfate in 197 parts of ion-exchanged water, was added to “Resin Particle a1-2”, obtained as described above, followed by dripping a monomer mixture liquid containing 274 parts of styrene, 169 parts of n-butyl acrylate, 5 parts of methacrylic acid, and 7 parts of n-octyl mercaptan into the resultant reaction mixture under a temperature condition of 80° C. over an hour. After dripping, a third stage polymerization (formation of an outer layer) was carried out by heating while stirring for two hours, followed by cooling the system to 25° C. to obtain “Core Resin Particle A1.”

The weight average particle diameter of the complex resin particles (being the resin particles) constituting “Core Resin Particle A1” was 155 nm. Further, the glass transition point (Tg) of the resin particles was 21° C., and the solubility parameter (SP value) was 10.10.

### <Preparation of Core Resin Particle A2>

(1) First Stage Polymerization

In a 5 l reaction vessel fitted with a stirrer, a thermal sensor, a cooling pipe, and a nitrogen introducing unit, 96 parts of paraffin wax “HNP-57” (produced by Nihon Seiro Co. Ltd.) as a releasing agent were added to a mixture liquid containing 101 parts of styrene, 62 parts of n-butyl acrylate, and 12 parts of methacrylic acid, followed by elevating the temperature to 85° C. to dissolve the resultant reaction mixture.

On the other hand, a surfactant solution was prepared by dissolving 3 parts of the anion surfactant S, being the same as described above, in 1,560 parts of ion-exchanged water.

After this surfactant solution was heated to 98° C., the polymerizable monomer solution was mixed and dispersed for two hours using mechanical system homogenizer “CLEAR MIX” fitted with a circulatory path (produced by M Technique Co., Ltd.), whereby an emulsion liquid incorporating emulsified particles containing dispersion particles (250 nm) was prepared.

Subsequently, after adding 1,460 parts of ion-exchanged water, an initiator solution, prepared by dissolving 6 parts of the polymerization initiator (potassium persulfate) in 200 parts of ion-exchanged water, as well as 2 parts of n-octyl mercaptan were added, and the temperature was elevated to 80° C. Thereafter, polymerization (a first stage polymerization) was carried out by heating the system at 80° C. for three hours while stirring to prepare resin particles, being referred to as “Resin Particle a2-1.” The weight average molecular weight (Mw) of “Resin Particle a2-1”, prepared in the first stage polymerization, was 23,600.

(2) Second Stage Polymerization (Preparation of an Outer Layer)

An initiator solution, prepared by dissolving 6 parts of potassium persulfate in 230 parts of ion-exchanged water, was added to “Resin Particle a2-1”, obtained as described above, followed by dripping a monomer mixture liquid containing 294 parts of styrene, 155 parts of n-butyl acrylate, and 7 parts of n-octyl mercaptan into the resultant mixture under a temperature condition of 80° C. over an hour. After dripping, a second stage polymerization (formation of an outer layer) was carried out by heating while stirring for two hours, followed by cooling the system to 25° C. to obtain “Core Resin Particle A2.”

The weight average particle diameter of the complex resin particles (being the resin particles) constituting “Core Resin Particle A2” was 130 nm. Further, the glass transition point (Tg) of the resin particles was 28° C., and the solubility parameter (SP value) was 10.09.

### <Preparation of Core Resin Particle A3>

“Core Resin Particle A3” was prepared in the same manner as for “Core Resin Particle A2”, except that the mixture liquid used in the first stage polymerization (formation of an inner layer) was changed to one containing 116 parts of styrene, 48 parts of n-butyl acrylate, 12 parts of methacrylic acid, and 8 parts of n-octyl mercaptan, and the initiator solution was changed to one prepared by dissolving 6 parts of potassium persulfate in 239 parts of ion-exchanged water.

### <Preparation of Core Resin Particle A4>

“Core Resin Particle A4” was prepared in the same manner as for “Core Resin Particle A1”, except that the monomer mixture liquid used in the third stage polymerization (formation of an outer layer) was changed to one containing 300 parts of styrene, 147 parts of n-butyl acrylate, 3 parts of methacrylic acid, and 5 parts of n-octyl mercaptan, and the initiator solution was changed to one prepared by dissolving 4 parts of potassium persulfate in 148 parts of ion-exchanged water.

### <Preparation of Core Resin Particle A5>

“Core Resin Particle A5” was prepared in the same manner as for “Core Resin Particle A2”, except that the mixture liquid used in the first stage polymerization (formation of an inner layer) was changed to one containing 115 parts of styrene, 37 parts of n-butyl acrylate, 12 parts of methacrylic acid, and 8 parts of n-octyl mercaptan, and the initiator solution was changed to one prepared by dissolving 6 parts of potassium persulfate in 200 parts of ion-exchanged water.

The weight average molecular weights (Mw's), average particle diameters, glass transition points Tg1's, solubility parameters (SP values), and softening points Tsp's of Core Resin Particles A1-A5 are listed in Table 1.

TABLE 1

| | Weight | Average | | | |
|---|---|---|---|---|---|
| Core Resin | Average | Particle | | | |
| Particle | Molecular | Diameter | Tg1 | | |
| NO. | Weight (Mw) | (nm) | (° C.) | SP Value | Tsp (° C.) |
| Core Resin | 19800 | 155 | 21 | 10.10 | 76 |
| Particle A1 | | | | | |
| Core Resin | 24500 | 130 | 28 | 10.09 | 83 |
| Particle A2 | | | | | |
| Core Resin | 26000 | 152 | 38 | 10.09 | 92 |
| Particle A3 | | | | | |
| Core Resin | 25800 | 165 | 8 | 10.19 | 64 |
| Particle A4 | | | | | |
| Core Resin | 18200 | 144 | 52 | 10.09 | 108 |
| Particle A5 | | | | | |

### <Shell Resin Particles>

(Preparation of Shell Resin Particle B1)

“Shell Resin Particle B1” was prepared via polymerization and post-reaction treatments in the same manner as in the first stage polymerization for “Core Resin Particle A1”, except that a monomer mixture liquid containing 140 parts of styrene, 400 parts of methyl methacrylate, 240 parts of 2-ethyl hexyl methacrylate, 20 parts of methacrylic acid, and 17 parts of n-octyl mercaptan was utilized.

### (Preparation of Shell Resin Particle B2)

“Shell Resin Particle B2” was prepared via polymerization and post-reaction treatments in the same manner for “Shell Resin Particle B1”, except that a monomer mixture liquid containing 560 parts of styrene, 144 parts of 2-ethyl hexyl methacrylate, 96 parts of methacrylic acid, and 13 parts of n-octyl mercaptan was utilized as the one having been utilized in the preparation of “Shell Resin Particle B1.”

(Preparation of Shell Resin Particle B3)

“Shell Resin Particle B3” was prepared via polymerization and post-reaction treatments in the same manner as for “Shell Resin Particle B1”, except that a monomer mixture liquid containing 586 parts of styrene, 138 parts of 2-ethyl hexyl methacrylate, 56 parts of methacrylic acid, and 13 parts of n-octyl mercaptan was utilized as the one having been utilized in the preparation of “Shell Resin Particle B1.”

(Preparation of Shell Resin Particle B4)

“Shell Resin Particle B4” was prepared via polymerization and post-reaction treatments in the same manner as for “Shell Resin Particle B1”, except that a monomer mixture liquid containing 437 parts of styrene, 155 parts of 2-ethyl hexyl methacrylate, 208 parts of methacrylic acid, and 7 parts of n-octyl mercaptan was utilized as the one having been utilized in the preparation of “Shell Resin Particle B1.”

(Preparation of Shell Resin Particle B5)

“Shell Resin Particle B5” was prepared via polymerization and post-reaction treatments in the same manner as for “Shell Resin Particle B1”, except that a monomer mixture liquid containing 624 parts of styrene, 120 parts of 2-ethyl hexyl methacrylate, 56 parts of methacrylic acid, and 13 parts of n-octyl mercaptan was utilized as the one having been utilized in the preparation of “Shell Resin Particle B1.”

### (Preparation of Shell Resin Particle B6)

“Shell Resin Particle B6” was prepared via polymerization and post-reaction treatments in the same manner as for “Shell Resin Particle B1”, except that a monomer mixture liquid containing 144 parts of styrene, 400 parts of methyl methacrylate, 240 parts of 2-ethyl hexyl methacrylate, 56 parts of methacrylic acid, 16 parts of itaconic acid, and 8 parts of n-octyl mercaptan was utilized as the one having been utilized in the preparation of “Shell Resin Particle B1.”

(Preparation of Shell Resin Particle B7)

“Shell Resin Particle B7” was prepared via polymerization and post-reaction treatments in the same manner as for “Shell Resin Particle B1”, except that a monomer mixture liquid containing 624 parts of styrene, 120 parts of 2-ethyl hexyl methacrylate, and 56 parts of methacrylic acid was utilized as the one having been utilized in the preparation of “Shell Resin Particle B1.”

(Preparation of Shell Resin Particle B8)

“Shell Resin Particle B8” was prepared via polymerization and post-reaction treatments in the same manner as for “Shell Resin Particle B1”, except that the monomer mixture liquid in the preparation of “Shell Resin Particle B1” was changed to one containing 586 parts of styrene, 138 parts of 2-ethyl hexyl methacrylate, 56 parts of methacrylic acid, and 8 parts of n-octyl mercaptan.

(Preparation of Shell Resin Particle B9)

“Shell Resin Particle B9” were prepared via polymerization and post-reaction treatments in the same manner as for “Shell Resin Particle B1”, except that the monomer mixture liquid in the preparation of “Shell Resin Particle B1” was changed to one containing 635 parts of styrene, 110 parts of 2-ethyl hexyl methacrylate, 55 parts of methacrylic acid, and 12 parts of n-octyl mercaptan.

The weight average molecular weights (Mw's), average particle diameters, glass transition points Tg2's, and solubility parameters (SP values) of Shell Resin Particles B1-B9 are listed in Table 2.

TABLE 2

| | Weight | Average | | |
|---|---|---|---|---|
| Shell Resin | Average | Particle | | |
| Particle | Molecular | Diameter | Tg2 | SP |
| NO. | Weight (Mw) | (nm) | (° C.) | Value |
| Shell Resin | 30000 | 85 | 51 | 9.76 |
| Particle B1 | | | | |
| Shell Resin | 36000 | 125 | 57 | 10.60 |
| Particle B2 | | | | |
| Shell Resin | 27300 | 123 | 58 | 10.54 |
| Particle B3 | | | | |
| Shell Resin | 61200 | 122 | 70 | 11.21 |
| Particle B4 | | | | |
| Shell Resin | 29000 | 111 | 61 | 10.48 |
| Particle B5 | | | | |
| Shell Resin | 55500 | 77 | 50 | 9.77 |
| Particle B6 | | | | |
| Shell Resin | 72100 | 113 | 75 | 10.48 |
| Particle B7 | | | | |
| Shell Resin | 51000 | 120 | 58 | 10.54 |
| Particle B8 | | | | |
| Shell Resin | 33400 | 105 | 38 | 10.38 |
| Particle B9 | | | | |

### <Preparation of Toners>

Toner 1-Toner 12 were prepared, as described below.

<Colored Particle 1>

(Preparation of Colorant Particle Dispersion 1)

Ninety parts of the anion surfactant S, being the same as described above, were dissolved in 1,600 parts of ion-exchanged water while stirring. While stirring this solution, 400 parts of carbon black “REGAL 330” (produced by Cabot Corp.) were added gradually, followed by being dispersed using homogenizer “CLEAR MIX” fitted with a circulatory path (produced by M Technique Co., Ltd.) to prepare “Colorant Particle Dispersion 1.”

The particle diameter of the colorant particles in “Colorant Particle Dispersion 1” was determined to be 110 nm using electrophoretic light scattering spectrophotometer “ELS-800” (produced by Otsuka Electronics Co., Ltd.).

(Salting-Out/Fusion (Aggregation•Fusion) Process) (Formation of a Core)

After 421 parts, in terms of a solid content, of “Core Resin Particle A1”, 900 parts of ion-exchanged water, and 200 parts of “Colorant Particle Dispersion 1” were placed in a reaction vessel fitted with a thermal sensor, a cooling pipe, a nitrogen introducing unit, and a stirrer, the resultant mixture was stirred. The internal temperature of the vessel was adjusted at 30° C., followed by adding a 5 mol/l aqueous solution of sodium hydroxide to the resultant solution to allow pH to be 8-11.

Further, a solution, prepared by dissolving 2 parts of magnesium chloride hexahydrate in 1,000 parts of ion-exchanged water, was added at 30° C. over 10 minutes while stirring. After the system was allowed to stand for three minutes, followed by elevating the temperature to 65° C. over 60 minutes. In this state, the particle diameter of associated particles was determined with “COULTER COUNTER TA-II” (produced by Beckman Coulter, Inc.). When a median diameter (D₅₀) of the particles reached 5.5 μm, 40 parts of sodium chloride was dissolved in 1,000 parts of ion-exchanged water.

Particle diameter growing was terminated by adding the aqueous solution, and further fusion was continued by heating while stirring at a liquid temperature of 73° C. for two hours as a ripening treatment, resulting in forming “Core Resin Particle A1.”

The circularity of “Core Resin Particle A1” was determined to be 0.918 with “FPIA 2000” (produced by Sysmex Corp.).

(Formation of a Shell (Shelling Operation))

Subsequently, 96 parts of “Shell Resin Particle B1” were added at 55° C., and further an aqueous solution, prepared by dissolving 2 parts of magnesium chloride hexahydrate in 1,000 parts of ion-exchanged water, was added over 10 minutes, followed by elevating the temperature to 65° C. (being a shell formation temperature). Under continuous stirring for an hour, particles of “Shell Resin Particle B1” were allowed to fuse with the surface of “Core Resin Particle A1”, followed by being ripened at 75° C. for 30 minutes to form a shell.

At this stage, 40 parts of sodium chloride were added and the system was cooled to 30° C. under a condition of 8° C./min. The resultant fused particles were filtered, and washed repeatedly with ion-exchanged water of 45° C., followed by being dried at 40° C. to obtain “Colored Particle 1” incorporating shells formed on the surfaces of the core particles.

<Preparation of Colored Particle 2—Colored Particle 12>

“Colored Particle 2”—“Colored Particle 12” were prepared in the same manner as for “Colored Particle 1” except that “Core Resin Particle A1” and “Shell Resin Particle B1”, having been used in the preparation of “Colored Particle 1”, were changed to the core resin particles listed in Table 1 and the shell resin particles listed in Table 2, respectively, according to Table 3, and further the core particle circularities and shell formation temperatures were changed, as listed in Table 4.

### <External Additive Treatment Process>

Hydrophobic silica (number average primary particle diameter: 12 nm, degree of hydrophobicity: 68) and hydrophobic titanium oxide (number average primary particle diameter: 20 nm; degree of hydrophobicity: 63), were added to each of “Colored Particle 1”—“Colored Particle 12”, having been prepared, in which the added amounts of hydrophobic silica and hydrophobic titanium oxide were 1% and 1.2% by weight based on each of the colored particles, respectively, followed by being mixed using a HENSCHEL mixer.

The glass transition points Tg's, 50% aggregation rate temperatures Ta's, and weight average molecular weights (Mw's) of “Toner 1”-“Toner 12”, having been obtained in such manners, were determined.

The 50% aggregation rate temperature (Ta) of the toner was determined via the method described above.

The weight average molecular weight (Mw) was determined using gel-permeation chromatography “807-1T Type” (produced by JASCO Corp.). As a column temperature was kept at 40° C., tetrahydrofuran as a carrier solvent was passed at a rate of 1 kg/cm². Thirty mg of a specimen was dissolved in 20 ml of tetrahydrofuran, followed by introducing 0.5 mg of this solution, together with the carrier solution, into the apparatus to determine the weight average molecular weight in terms of polyethylene.

The results are listed in Table 4. Both the glass transition point Tg and (Ta−Tg) of each of Toner 1-Toner 8 satisfy the requirements for the present invention, while the glass transition point of Toner 9 is too low and (Ta−Tg) thereof is too small, and the glass transition point of Toner 10 is too high and (Ta−Tg) is too large. The glass transition points of Toners 11 and 12 satisfy the requirements for the present invention, while (Ta−Tg) of Toner 11 is too large and that of Toner 12 is too small.

Further, in Table 4, Example 1-Example 8 are relevant to Toner 1-Toner 8, respectively, and Comparative Example 1-Comparative Example 8 are relevant to Toner 9-Toner 12, respectively.

TABLE 3

| | Core Resin Particle | | | | Shell Resin Particle | | | | | | |
|---|---|---|---|---|---|---|---|---|---|---|---|
| Toner | | Tg1 | SP1 | Molecular | | Tg2 | SP2 | Molecular | Tg2 − Tg1 | ΔSP | |
| No. | No. | (° C.) | Value | Weight Mw1 | No. | (° C.) | Value | Weight Mw2 | (° C.) | \|SP2 − SP1\| | Mv2 − Mv1 |
| 1 | Resin | 21 | 10.10 | 19800 | Resin | 51 | 9.76 | 30000 | 30 | 0.34 | 10200 |
| | Particle A1 | | | | Particle B1 | | | | | | |
| 2 | Resin | 28 | 10.09 | 24500 | Resin | 57 | 10.60 | 36000 | 29 | 0.51 | 11500 |
| | Particle A2 | | | | Particle B2 | | | | | | |
| 3 | Resin | 28 | 10.09 | 24500 | Resin | 58 | 10.54 | 27300 | 30 | 0.45 | 2800 |
| | Particle A2 | | | | Particle B3 | | | | | | |
| 4 | Resin | 38 | 10.09 | 26000 | Resin | 70 | 11.21 | 61200 | 32 | 1.12 | 35200 |
| | Particle A3 | | | | Particle B4 | | | | | | |
| 5 | Resin | 21 | 10.10 | 19800 | Resin | 61 | 10.48 | 29000 | 40 | 0.38 | 9200 |
| | Particle A1 | | | | Particle B5 | | | | | | |
| 6 | Resin | 38 | 10.09 | 26000 | Resin | 58 | 10.54 | 51000 | 20 | 0.45 | 25000 |
| | Particle A3 | | | | Particle B8 | | | | | | |
| 7 | Resin | 28 | 10.09 | 24500 | Resin | 50 | 9.77 | 55500 | 22 | 0.32 | 31000 |
| | Particle A2 | | | | Particle B6 | | | | | | |
| 8 | Resin | 28 | 10.09 | 24500 | Resin | 38 | 10.38 | 33400 | 10 | 0.19 | 8900 |
| | Particle A2 | | | | Particle B9 | | | | | | |
| 9 | Resin | 8 | 10.19 | 25800 | Resin | 50 | 9.77 | 55500 | 42 | 0.42 | 29700 |
| | Particle A4 | | | | Particle B6 | | | | | | |
| 10 | Resin | 52 | 10.09 | 18200 | Resin | 75 | 10.48 | 72100 | 23 | 0.39 | 53900 |
| | Particle A5 | | | | Particle B7 | | | | | | |
| 11 | Resin | 28 | 10.09 | 27300 | Resin | 70 | 11.21 | 61200 | 42 | 1.12 | 33900 |
| | Particle A2 | | | | Particle B4 | | | | | | |
| 12 | Resin | 28 | 10.09 | 24500 | Resin | 52 | 10.09 | 18200 | 24 | 0.00 | −6300 |
| | Particle A2 | | | | Particle B5 | | | | | | |

The substance values relating to each of the toners in the examples and comparative examples are listed in Table 4.

TABLE 4

| | | | | Toner | | | | | | | | |
|---|---|---|---|---|---|---|---|---|---|---|---|---|
| | | | | Average | | | | | | | | |
| | | | | Median | | | | | | 8 Point | | |
| | | | | Particle | | Core | | | | Average | | |
| | | Core | Shell | Diameter | Core | Formation | | | | Film | | Core |
| | Toner | (weight | (weight | (D₅₀) | Particle | Temperature | Tg | Ta | Ta − Tg | Thickness | Hmax/ | Particle |
| | No. | %) | %) | (μm) | Circularity | (° C.) | (° C.) | (° C.) | (° C.) | (nm) | Hmin | Exposure |
| Example 1 | 1 | 90 | 10 | 5.6 | 0.916 | 60 | 21 | 36 | 15 | 230 | 1.25 | Unobserved |
| Example 2 | 2 | 85 | 15 | 5.7 | 0.930 | 65 | 32 | 52 | 20 | 220 | 1.14 | Unobserved |
| Example 3 | 3 | 88 | 12 | 5.5 | 0.942 | 70 | 30 | 56 | 26 | 221 | 1.12 | Unobserved |
| Example 4 | 4 | 90 | 10 | 5.5 | 0.925 | 70 | 40 | 75 | 35 | 210 | 1.13 | Unobserved |
| Example 5 | 5 | 88 | 12 | 5.5 | 0.938 | 65 | 21 | 60 | 39 | 223 | 1.15 | Unobserved |
| Example 6 | 6 | 88 | 12 | 5.5 | 0.930 | 65 | 38 | 56 | 18 | 227 | 1.14 | Unobserved |
| Example 7 | 7 | 88 | 12 | 5.5 | 0.900 | 65 | 29 | 51 | 22 | 231 | 1.31 | Unobserved |
| Example 8 | 8 | 88 | 12 | 5.5 | 0.912 | 65 | 28 | 44 | 16 | 228 | 1.25 | Unobserved |
| Comparative | 9 | 90 | 10 | 5.5 | 0.900 | 50 | 12 | 22 | 10 | 230 | 1.30 | Unobserved |
| Example 1 | | | | | | | | | | | | |
| Comparative | 10 | 90 | 10 | 5.6 | 0.945 | 75 | 52 | 99 | 47 | 220 | 1.20 | Unobserved |
| Example 2 | | | | | | | | | | | | |
| Comparative | 11 | 80 | 20 | 5.5 | 0.880 | 65 | 29 | 78 | 49 | 400 | 2.10 | Unobserved |
| Example 3 | | | | | | | | | | | | |
| Comparative | 12 | 90 | 10 | 5.6 | 0.820 | 65 | 38 | 48 | 10 | 280 | 4.50 | Observed |
| Example 4 | | | | | | | | | | | | |

### <Preparation of Developers>

Subsequently, ferrite carriers of a 50 μm volume average particle diameter, coated with a silicone resin, were mixed with each of the toners to prepare “Developer 1”-“Developer 12”, each of which has a 6% toner concentration.

### <Evaluations>

The following evaluations were carried out using Developer 1-Developer 8 in Example 1-Example 8 and Developer 9-Developer 12 in Comparative Example 1-Comparative Example 4, described above.

In addition, A and B in the evaluation criteria are ranked as “acceptable”, and C therein is ranked as “unacceptable.”

The image formation onto 50,000 sheets of A4-size paper was carried out in a one-sheet intermittent mode using bizhub PRO C500 (produced by Konica Minolta Business Technologies, Inc.) at 33° C. under an ambience of a 80% RH relative humidity, in which an image having a 10% image ratio (being an original image having a character image of a 10% image ratio, a portrait picture, a solid white image, and a solid black image, each divided into four equal parts) was employed.

### <Fog>

Fog density measurement was carried out using Macbeth Reflective Densitometer “RD-918” as follows: initially, the absolute image densities at 20 random points on unprinted white paper were measured and averaged to obtain a white paper density; thereafter, the absolute image densities at 20 random points on the white portions, as the formed images for the evaluation, on the 50,000th sheet, were measured in the same way, and averaged to obtain an average density. A value, obtained by subtracting the white paper density from the average density, was evaluated as the fog density.

In cases in which the fog density is at most 0.010, it is possible to say that the fog is not substantially problematic.

The evaluation criteria for the fog density are as follows: A: less than 0.003; B: 0.003—at most 0.010; and C: more than 0.010.

### <Image Non-Uniformity>

After 50,000-sheet image formation, an original, having a solid image at an original reflection density of 1.30 at five points, i.e. four corners and the central portion of the image, was copied, and relative reflection densities of the five points of the output image were measured against the white paper, resulting in obtaining the difference between the maximum value and the minimum value of the image reflection densities regarded as image non-uniformity.

Herein, image non-uniformity at a value of at most 0.05 was evaluated to be favorable. Herein, the evaluation was conducted at the end of the image formation.

The evaluation criteria are as follows: A: at most 0.05, and B: more than 0.05.

### <Low Temperature Fixability>

Low temperature fixability was measured as follows: the surface temperature of the heating roller (temperatures were measured in the roller center) of an image evaluation device was allowed to vary at regular intervals of 5° C. in the range of 90-130° C.; at each of the surface temperatures, an A4 image having a solid black belt-like image of a 5 mm width and a halftone image of a 20 mm width, perpendicular to the transportation direction, was transported via transverse feeding; and then evaluation was carried out in a temperature region (namely a non-offsetting region), in which no image blemish are caused by the offsetting of the fixed image.

The evaluation criteria for low temperature fixability are as follows: A: the lower limit temperature in a non-offsetting region is at most 110° C. and the temperature region is at least 15° C.; B: the lower limit temperature in a non-offsetting region is at most 120° C. and the temperature region is less than 15° C.; and C: the lower limit temperature in a non-offsetting region is more than 125° C.

### <Fixing Intensity Via a Rubbing Test>

Image density was measured with respect to a patch portion of a fixed image using Macbeth Reflective Densitometer “RD-918.” A relative density against white paper was regarded as the image density, and the patch portion of a density of 1.00±0.05 was selected as a measuring portion. The measuring portion was rubbed 14 times at a load of 22 g/cm² using bleached plain-woven cotton. After rubbing, the image density of the measuring portion was measured, and the density ratio before and after rubbing was designated as a fixing ratio.

Fixing ratio (%)=((image density after rubbing)/(image density before rubbing))×100

A fixing ratio of at least 80% may be ranked to be practically nonproblematic as follows:

A: a fixing ratio is at least 90%

B: a fixing ratio is at least 80%, and

C: a fixing ratio is less than 80%.

TABLE 5

| | | | | Fixing |
|---|---|---|---|---|
| | | | | Intensity |
| | | Image Non- | Low Temperature | via a |
| Sample | Fog | uniformity | Fixability | Rubbing Test |
| Example 1 | B | A | A | A |
| Example 2 | A | A | A | A |
| Example 3 | A | A | A | B |
| Example 4 | A | A | A | A |
| Example 5 | A | A | A | B |
| Example 6 | B | A | A | A |
| Example 7 | A | A | A | A |
| Example 8 | B | A | A | B |
| Comparative | C | B | A | B |
| Example 1 | | | | |
| Comparative | A | A | C | C |
| Example 2 | | | | |
| Comparative | A | A | B | C |
| Example 3 | | | | |
| Comparative | C | B | A | B |
| Example 4 | | | | |

As being apparent from Table 5, it is understandable that the toners employed in Example 1-Example 8, satisfying the requirements for the present invention, each exhibit excellent properties.

In contrast, the toners employed in Comparative Example 1-Comparative Example 4, which do not satisfy the requirements for the present invention, each have problems about some properties.

What is claimed is:

1. An electrophotographic toner comprising toner particles each containing a colorant and a resin,
wherein the resin in the toner particle satisfies the following Formulas (1) and (2):
20≦Tg≦40 Formula (1)
15≦(Ta−Tg)≦40, Formula (2)
wherein Tg (° C.) is a glass transition point of the resin; and Ta (° C.) is a 50% aggregation temperature of the resin.

2. The electrophotographic toner of claim 1,
wherein the resin in the toner particle satisfies the following Formulas (3) and (4):
25≦Tg≦35 Formula (3)
20≦(Ta−Tg)≦35, Formula (4)
wherein Tg (° C.) is a glass transition point of the resin; and Ta (° C.) is a 50% aggregation temperature of the resin.

3. The electrophotographic toner of claim 1,
wherein the toner particle has a core/shell structure comprising a core and a shell covering a surface of the core.

4. The electrophotographic toner of claim 3,
wherein a first glass transition temperature (Tg1) of a first resin in the core and a second glass transition temperature (Tg2) of a second resin in the shell satisfy the following Formula (5):
Tg1<Tg2. Formula (5)

5. The electrophotographic toner of claim 3,
wherein Tg2 is larger than Tg1 by 20° C. or more.

6. The electrophotographic toner of claim 3,
wherein a first solubility parameter (SP1) of a first resin in the core and a second solubility parameter (SP2) of a second resin in the shell satisfy the following Formula (5B):
0.19≦|SP1−SP2|≦1.12 Formula (5B)

7. The electrophotographic toner of claim 3,
wherein a first solubility parameter (SP1) of a first resin in the core and a second solubility parameter (SP2) of a second resin in the shell satisfy the following Formula (5C):
0.32≦|SP1−SP2|≦1.12 Formula (5C)

8. The electrophotographic toner of claim 3,
wherein an average layer thickness obtained from thicknesses at 8 points of the shell is 100 to 300 nm; and
a ratio of Hmax/Hmin is less than 1.50, provided that Hmax is a maximum layer thickness of the shell and Hmin is a minimum layer thickness of the shell.

9. The electrophotographic toner of claim 3,
wherein an entire portion of the surface of the core is covered with the shell.
